(19) United States
(12) Patent Application Publication
(10) Pub. No.: US 2025/0286201 A1
(43) Pub. Date: Sep. 11, 2025

(54) ELECTRICITY STORAGE DEVICE

(71) Applicant: TOYOTA JIDOSHA KABUSHIKI KAISHA, Toyota-shi (JP)

(72) Inventors: Kazuki SUGIE, Miyoshi-shi (JP); Akio MORI, Toyota-shi (JP); Yoshiro KAMO, Ashigarakami-gun (JP); Takahiko NAKANO, Nagoya-shi (JP); Toshihiro SHIMONAKA, Toyota-shi (JP); Kenichi KOHASHI, Sunto-gun (JP); Yuki SODA, Nagoya-shi (JP)

(73) Assignee: TOYOTA JIDOSHA KABUSHIKI KAISHA, Toyota-shi (JP)

(21) Appl. No.: 18/956,319

(22) Filed: Nov. 22, 2024

(30) Foreign Application Priority Data
Mar. 6, 2024 (JP) 2024-033837

(51) Int. Cl. H01M 50/293; H01M 10/613; H01M 50/249; H01M 50/507; H01M 50/548

(52) U.S. Cl. CPC H01M 50/293; H01M 10/613; H01M 50/507; H01M 50/548; H01M 50/249

(57) ABSTRACT

An electricity storage device includes: an electricity storage module including a plurality of electricity storage cells; an adhesive material that causes the electricity storage cells to adhere to each other; and an inter-cell busbar. Each of the electricity storage cells includes a first short side surface and a second short side surface, a negative electrode terminal provided on the first short side surface, and a positive electrode terminal provided on the second short side surface. The electricity storage cells are disposed such that the positive electrode terminal and the negative electrode terminal of the electricity storage cells adjacent to each other in a Y direction are adjacent to each other. The inter-cell busbar connects the positive electrode terminal and the negative electrode terminal adjacent to each other. The adhesive material causes the first short side surface and the second short side surface to adhere to each other.

### CROSS-REFERENCE TO RELATED APPLICATION

This application claims priority to Japanese Patent Application No. 2024-033837 filed on Mar. 6, 2024, incorporated herein by reference in its entirety.

### BACKGROUND

### 1. Technical Field

The present disclosure relates to an electricity storage device.

### 2. Description of Related Art

Japanese Unexamined Patent Application Publication (Translation of PCT Application) No. 2022-512496 (JP 2022-512496 A) discloses a battery pack in which sub-modules each including a plurality of unit cells are coupled to each other by a busbar.

### SUMMARY

In the battery pack described in JP 2022-512496 A, when an impact is applied from outside, the busbar is considered to be damaged due to occurrence of positional misalignment between the sub-modules.

The present disclosure has been made to solve the above-mentioned problem, and has an object to provide an electricity storage device capable of preventing a busbar that connects electricity storage cells to each other from being damaged.

An electricity storage device according to one aspect of the present disclosure includes: an electricity storage module including a plurality of electricity storage cells arrayed in a first direction; a case that accommodates the electricity storage module; an adhesive material that causes the electricity storage cells to adhere to each other; and an inter-cell busbar that connects, out of the electricity storage cells, electricity storage cells adjacent to each other in the first direction. Each of the electricity storage cells includes: a side surface in a second direction intersecting with the first direction; and a terminal provided on the side surface. The electricity storage cells are disposed such that the terminals of the electricity storage cells adjacent to each other in the first direction are adjacent to each other. The inter-cell busbar connects the terminals adjacent to each other. The adhesive material causes the side surfaces adjacent to each other in the first direction to adhere to each other.

In the electricity storage device according to the one aspect of the present disclosure, as described above, the adhesive material causes the side surfaces adjacent to each other in the first direction to adhere to each other. Thus, the adhesive material can prevent positional misalignment from occurring between the electricity storage cells (the side surfaces) adjacent to each other in the first direction. As a result, it is possible to prevent a stress from being applied to the inter-cell busbar connecting the terminals provided on the respective adjacent side surfaces due to the above-mentioned positional misalignment. Thus, it is possible to prevent the inter-cell busbar from being damaged.

The adhesive material may cause the adjacent side surfaces respectively provided with the adjacent terminals that are connected by the inter-cell busbar to adhere to each other. With such a configuration, the side surfaces connected (fixed) by the inter-cell busbar can adhere to each other by the adhesive material, and hence it is possible to prevent a stress from being applied to the inter-cell busbar due to the above-mentioned positional misalignment.

The adhesive material may include a first adhesion part and a second adhesion part that are provided such that the inter-cell busbar is interposed between the first adhesion part and the second adhesion part. With such a configuration, as compared to a case in which the adhesive material includes any one of the first adhesion part and the second adhesion part, the adjacent side surfaces can be more stably (firmly) fixed to each other. As a result, it is possible to prevent the inter-cell busbar from being damaged.

The electricity storage device may include a cooler including a cooling surface on which the electricity storage cells are arrayed. The adhesive material may be provided on the cooler side with respect to the inter-cell busbar. With such a configuration, it is possible to easily prevent positional misalignment from occurring between the side surfaces on the cooler side with respect to the inter-cell busbar. Thus, the present disclosure is particularly effective when the above-mentioned positional misalignment is liable to occur at a position on the cooler side due to a relatively weak adhesive force between the electricity storage cell and the cooler.

The adhesive material may have a band shape extending in the first direction. With such a configuration, the adhesion area between the adhesive material and the side surface can be easily increased. As a result, the adhesive force by the adhesive material can be easily increased.

According to the present disclosure, it is possible to prevent the busbar connecting the electricity storage cells to each other from being damaged.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating a configuration of a vehicle on which an electricity storage device according to one embodiment is mounted;

FIG. 2 is an exploded perspective view illustrating a configuration of the electricity storage device according to the one embodiment and a vehicle framework;

FIG. 3 is an exploded perspective view illustrating a detailed configuration of the electricity storage device according to the one embodiment;

FIG. 4 is a perspective view illustrating a configuration of the electricity storage device according to the one embodiment;

FIG. 5 is a sectional view illustrating the configuration of the electricity storage device according to the one embodiment; and

FIG. 6 is a plan view illustrating the configuration of the electricity storage device according to the one embodiment.

### DETAILED DESCRIPTION OF EMBODIMENTS

Hereinafter, with reference to the drawings, embodiments and modification examples according to the present disclosure are described. In the following description, like parts and components are denoted by like reference symbols. The same holds true for the names and the functions thereof. Thus, detailed description of those is not repeated. It is to be noted that the embodiments and the modification examples described below may be selectively combined as appropriate.

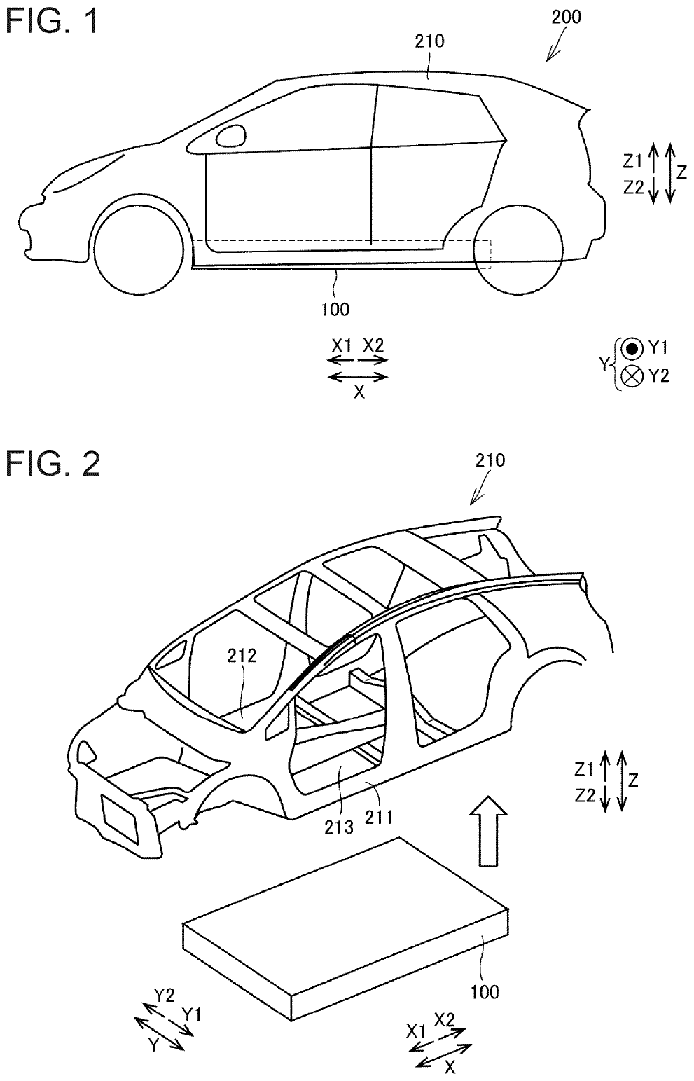

With reference to FIG. 1 to FIG. 6, an electricity storage device according to this embodiment and a vehicle including the electricity storage device are described. FIG. 1 is a side view schematically illustrating a vehicle 200 including an electricity storage device 100 according to this embodiment. It is to be noted that an X direction, a Y direction, and a Z direction as used herein are directions orthogonal to each other. For example, the X direction and the Y direction are a front-rear direction and a width direction, respectively, of the vehicle 200 when the electricity storage device 100 is mounted on the vehicle 200. Further, the Z direction is the vertical direction. It is to be noted that the X direction and the Y direction are examples of a “second direction” and a “first direction” of the present disclosure, respectively.

With reference to FIG. 1, the electricity storage device 100 is disposed below a floor panel 213 (FIG. 2) of the vehicle 200. Examples of the vehicle 200 include a hybrid electric vehicle, a plug-in hybrid electric vehicle, a fuel cell electric vehicle, and a battery electric vehicle. The vehicle 200 includes the electricity storage device 100 and a vehicle framework 210.

FIG. 2 is an exploded perspective view schematically illustrating the electricity storage device 100 and the vehicle framework 210. With reference to FIG. 2, the vehicle framework 210 includes a left frame 211 and a right frame 212.

The left frame 211 and the right frame 212 are disposed at a bottom portion of the vehicle framework 210. The left frame 211 and the right frame 212 are disposed with an interval in the width direction (the Y direction) of the vehicle 200. Further, each of the left frame 211 and the right frame 212 is disposed so as to extend in the front-rear direction (the X direction) of the vehicle 200.

The floor panel 213 is provided between the left frame 211 and the right frame 212. The electricity storage device 100 is disposed below the floor panel 213, and is fixed to the left frame 211 and the right frame 212.

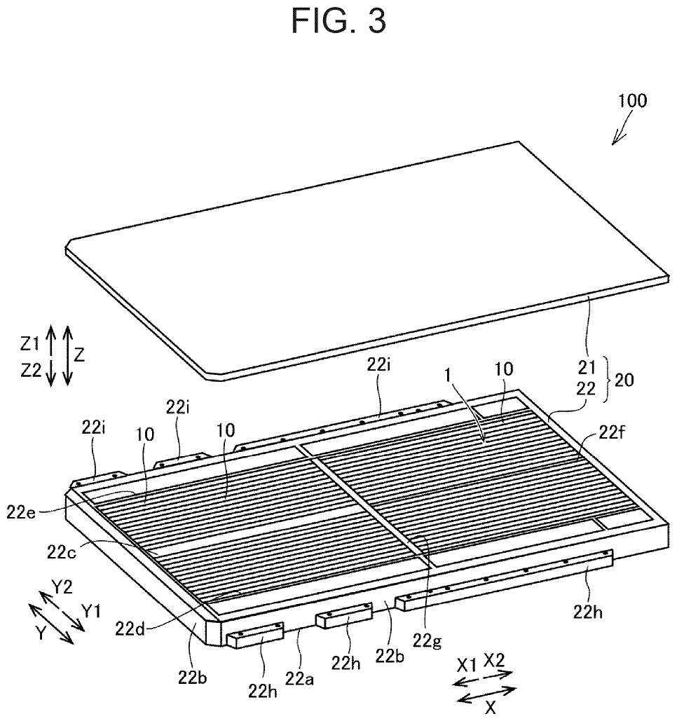

FIG. 3 is a perspective view schematically illustrating the electricity storage device 100. With reference to FIG. 3, the electricity storage device 100 includes an electricity storage module 1 including a plurality of electricity storage cells 10, and a case 20 that accommodates the electricity storage module 1.

The electricity storage cell 10 is a secondary battery, and is typically a lithium-ion secondary battery. The lithium-ion secondary battery is a battery using lithium as a charge carrier, and may include, in addition to a lithium-ion secondary battery using a liquid electrolyte, an all-solid-state battery using a solid electrolyte. It is to be noted that the electricity storage cell 10 is not limited to the lithium-ion secondary battery, and may be configured of a nickel-hydrogen secondary battery or other secondary batteries.

Each of the electricity storage cells 10 is disposed so as to extend in the front-rear direction (the X direction) of the vehicle 200 (see FIG. 1). Further, the electricity storage cells 10 are arrayed in the width direction (the Y direction) of the vehicle 200.

The case 20 includes an upper cover 21 and a lower case 22. FIG. 3 illustrates the electricity storage device 100 in a state in which the upper cover 21 is detached. The lower case 22 includes a bottom plate 22a, a peripheral wall 22b, and a plurality of partition walls 22c, 22d, 22c, 22f, 22g. The partition walls 22c, 22d, 22c, 22f, 22g divide a space in the case 20 into a plurality of sections.

The bottom plate 22a is formed in a flat plate shape. The peripheral wall 22b is formed so as to extend upward in the vehicle 200 from an outer peripheral edge portion of the bottom plate 22a. The peripheral wall 22b is formed in an annular shape. The partition walls 22c, 22d, 22c, 22f, 22g are provided on the bottom plate 22a. The partition walls 22c, 22d, 22e, 22f are each formed so as to extend in the front-rear direction (the X direction) of the vehicle 200. The partition wall 22g is formed so as to extend in the width direction (the Y direction) of the vehicle 200.

The partition wall 22g is disposed at the center in the front-rear direction (the X direction) of the vehicle 200. Each of the partition wall 22c and the partition wall 22f is disposed at the center in the width direction (the Y direction) of the vehicle 200. The partition wall 22c is disposed on the front side (the X1 side) of the vehicle 200 than the partition wall 22g. The partition wall 22f is disposed on the rear side (the X2 side) of the vehicle 200 than the partition wall 22g. A plurality of electricity storage cells 10 is accommodated in each space divided by the partition wall 22c, the partition wall 22d, the partition wall 22e, the partition wall 22f, and the partition wall 22g.

The lower case 22 further includes a plurality of support portions 22h and a plurality of support portions 22i. The support portions 22h and the support portions 22i are each fixed to the vehicle framework 210 (see FIG. 2). For example, the support portions 22h and the support portions 22i each have holes into which bolts are fitted. When the bolts are fitted into the holes, each of the support portions 22h is fixed to the left frame 211 (see FIG. 2), and each of the support portions 22i is fixed to the right frame 212 (see FIG. 2).

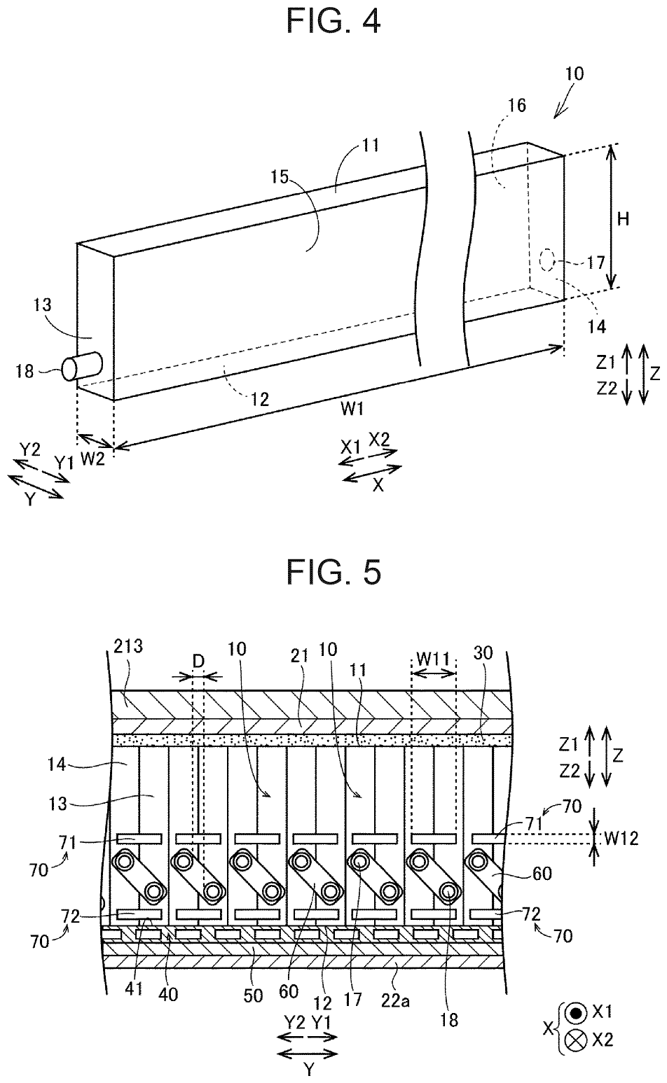

FIG. 4 illustrates an example of the electricity storage cell 10. With reference to FIG. 4, the electricity storage cell 10 includes an upper surface 11, a lower surface 12, a short side surface 13, a short side surface 14, a long side surface 15, and a long side surface 16. It is to be noted that each of the short side surface 13 and the short side surface 14 is an example of a “side surface” of the present disclosure.

Each of the upper surface 11 and the lower surface 12 is a surface of the electricity storage cell 10 in the Z direction. Specifically, the upper surface 11 is an end surface of the electricity storage cell 10 on the Z1 side. The lower surface 12 is an end surface of the electricity storage cell 10 on the Z2 side, and is a surface provided on the opposite side from the upper surface 11 in the Z direction.

Each of the short side surface 13 and the short side surface 14 is a surface of the electricity storage cell 10 in the X direction. Specifically, the short side surface 13 and the short side surface 14 are one end surface of the electricity storage cell 10 in the X direction and the other end surface of the electricity storage cell 10 in the X direction, respectively.

Each of the long side surface 15 and the long side surface 16 is a surface of the electricity storage cell 10 in the Y direction. Specifically, the long side surface 15 and the long side surface 16 are one end surface of the electricity storage cell 10 in the Y direction and the other end surface of the electricity storage cell 10 in the Y direction, respectively.

The electricity storage cell 10 is configured to have a longitudinal direction in the X direction. Specifically, a width WI of the electricity storage cell 10 in the X direction is larger than a width W2 of the electricity storage cell 10 in the Y direction. Further, the width WI is larger than a height H of the electricity storage cell 10 in the Z direction. It is to be noted that the height H is larger than the width W2.

The electricity storage cell 10 further includes a positive electrode terminal 17 and a negative electrode terminal 18. The positive electrode terminal 17 is provided on the short side surface 14. The negative electrode terminal 18 is provided on the short side surface 13. It is to be noted that each of the positive electrode terminal 17 and the negative electrode terminal 18 is an example of a “terminal” of the present disclosure.

FIG. 5 is a sectional view schematically illustrating the floor panel 213 and the electricity storage device 100. Further, FIG. 5 illustrates the short side surface 13 and the short side surface 14 as viewed from the X1 side.

With reference to FIG. 5, in the electricity storage device 100, the electricity storage cell 10 disposed such that the short side surface 13 faces the front (the X1 side) of the vehicle 200 (see FIG. 1) and the electricity storage cell 10 disposed such that the short side surface 14 faces the front of the vehicle 200 are alternately disposed along the width direction (the Y direction) of the vehicle 200. Thus, the positive electrode terminal 17 and the negative electrode terminal 18 of the electricity storage cells 10 adjacent to each other in the Y direction are disposed so as to be adjacent to each other.

The electricity storage device 100 includes an adhesive material 30 that causes the electricity storage cell 10 to adhere to the upper cover 21. The adhesive material 30 is made of resin. The adhesive material 30 is provided on the upper surface 11 of the electricity storage cell 10. More specifically, the adhesive material 30 is provided between the upper surface 11 of the electricity storage cell 10 and the upper cover 21, and along the upper surface 11. The electricity storage cells 10 are fixed to the upper cover 21 by the adhesive material 30.

The electricity storage device 100 further includes a cooler 40 that cools the electricity storage cell 10. The cooler 40 includes a cooling surface 41 on which the electricity storage cells 10 are disposed. The cooling surface 41 is an end surface of the cooler 40 on the Z1 side. The cooler 40 (cooling surface 41) is provided along the lower surface 12 of the electricity storage cell 10. It is to be noted that FIG. 5 illustrates an example in which no adhesive material (adhesive layer) is provided between the cooling surface 41 and the lower surface 12 of the electricity storage cell 10, but the adhesive material (adhesive layer) may be disposed at this position.

The electricity storage device 100 further includes an insulating plate 50. The insulating plate 50 is provided between the cooler 40 and the bottom plate 22a and along the bottom plate 22a.

The electricity storage device 100 includes a plurality of inter-cell busbars 60. The inter-cell busbar 60 connects the electricity storage cells 10 adjacent to each other in the Y direction. Specifically, the inter-cell busbar 60 connects the positive electrode terminal 17 and the negative electrode terminal 18 adjacent to each other. In detail, the inter-cell busbar 60 connects the positive electrode terminal 17 provided on one of the two electricity storage cells 10 adjacent to each other in the Y direction and the negative electrode terminal 18 provided on the other of the two electricity storage cells 10.

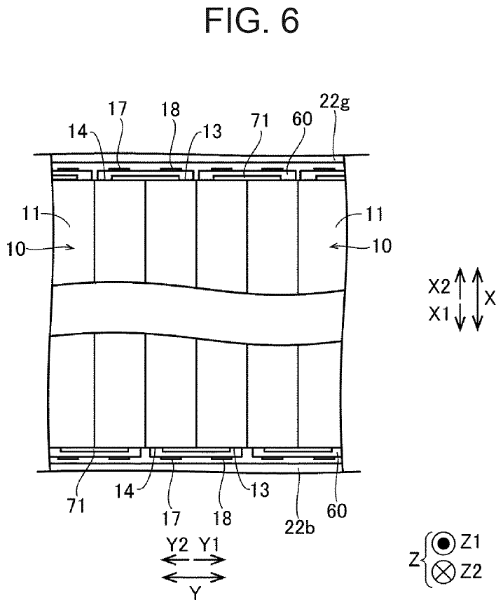

It is to be noted that, as illustrated in FIG. 6, also on the X2 side of the electricity storage module 1 opposite to the X1 side illustrated in FIG. 5, similarly, the inter-cell busbar 60 connects the positive electrode terminal 17 and the negative electrode terminal 18 adjacent to each other. Each electricity storage cell 10 (an electricity storage cell 10 other than the electricity storage cells 10 at both ends in the Y direction) is connected on the X1 side to the electricity storage cell 10 disposed on one side in the Y direction by the inter-cell busbar 60, and is connected on the X2 side to the electricity storage cell 10 disposed on the other side in the Y direction by the inter-cell busbar 60. Thus, the electricity storage cells 10 arrayed in the Y direction are electrically connected in series.

Here, in the electricity storage device of the related art, it is considered that the inter-cell busbar is damaged due to occurrence of positional misalignment between the adjacent electricity storage cells 10 when an impact is applied from outside or the like.

In view of the foregoing, in this embodiment, with reference back to FIG. 5, the electricity storage device 100 includes an adhesive material 70 that causes the short side surface 13 and the short side surface 14 adjacent to each other in the Y direction to adhere to each other. Specifically, the adhesive material 70 causes the short side surface 14 and the short side surface 13 provided with the positive electrode terminal 17 and the negative electrode terminal 18 that are connected by the inter-cell busbar 60, respectively, to adhere to each other. Accordingly, the combination of the electricity storage cells 10 that are caused to adhere by the adhesive material 70 is different between the X1 side and the X2 side of the electricity storage module 1 (see FIG. 6).

Further, as illustrated in FIG. 5, the adhesive material 70 includes a first adhesion part 71 and a second adhesion part 72. Each inter-cell busbar 60 is provided so as to be interposed between the first adhesion part 71 and the second adhesion part 72. Specifically, the first adhesion part 71 is provided on the Z1 side from the inter-cell busbar 60. The second adhesion part 72 is provided on the Z2 side from the inter-cell busbar 60. It is to be noted that the first adhesion part 71 and the second adhesion part 72 have the same shape and the same size.

The second adhesion part 72 is provided on the cooler 40 side with respect to the inter-cell busbar 60. In other words, the second adhesion part 72 is disposed between the inter-cell busbar 60 and the cooler 40.

Further, each inter-cell busbar 60 is disposed below (on the Z2 side of) the center of the electricity storage cell 10 in the Z direction. In contrast, the first adhesion part 71 is provided in the vicinity of the center of the electricity storage cell 10 in the Z direction. Further, the second adhesion part 72 is provided in the vicinity of the lower surface 12 of the electricity storage cell 10.

The adhesive material 70 (71, 72) has a band shape extending in the Y direction. The adhesive material 70 has a width W11 in the Y direction. The adhesive material 70 has a width W12 in the Z direction. The width W11 is larger than the width W12. The width W11 is, for example, four times the width W12 or more.

The width W11 of the adhesive material 70 in the Y direction is, for example, larger than the width W2 of the electricity storage cell 10 in the Y direction (FIG. 4). Further, the width W11 is larger than a distance D in the Y direction between the positive electrode terminal 17 and the negative electrode terminal 18 that are connected by the inter-cell busbar 60.

As described above, in the above-mentioned embodiment, the adhesive material 70 causes the short side surface 13 and the short side surface 14 adjacent to each other in the Y direction to adhere to each other. Thus, the adjacent electricity storage cells 10 are fixed to each other by the adhesive material 70, and hence it is possible to prevent a stress from being applied to the inter-cell busbar 60 connecting the adjacent electricity storage cells 10. As a result, it is possible to prevent the inter-cell busbar 60 from being damaged.

Further, in the above-mentioned embodiment, the second adhesion part 72 is provided on the cooler 40 side with respect to the inter-cell busbar 60. Thus, even when each electricity storage cell 10 is not caused to adhere to the cooler 40, the second adhesion part 72 can prevent the positional misalignment from occurring between parts of the adjacent electricity storage cells 10 on the cooler 40 side.

The above-mentioned embodiment has shown an example in which the negative electrode terminal 18 is provided on the short side surface 13 of the electricity storage cell 10, and the positive electrode terminal 17 is provided on the short side surface 14 of the electricity storage cell 10, but the present disclosure is not limited thereto. The positive electrode terminal 17 and the negative electrode terminal 18 may be provided on any one of the short side surface 13 and the short side surface 14. In this case, the adjacent short side surfaces (13 or 14) provided with the terminals (17, 18) are caused to adhere to each other by the adhesive material. It is to be noted that the adjacent short side surfaces (13 or 14) not provided with the terminals (17, 18) may be caused to adhere to each other by the adhesive material.

The above-mentioned embodiment has shown an example in which the first adhesion part 71 and the second adhesion part 72 are used for adhesion between the adjacent electricity storage cells 10, but the present disclosure is not limited thereto. Any one of the first adhesion part 71 and the second adhesion part 72 may be used for adhesion between the adjacent electricity storage cells 10.

The above-mentioned embodiment has shown an example in which the adhesive material 70 causes the side surfaces (13, 14) provided with the terminals (17, 18) that are connected by the inter-cell busbar 60 to adhere to each other, but the present disclosure is not limited thereto. For example, the adhesive material may cause the adjacent side surfaces (13, 14) provided with the terminals (17, 18) that are not connected by the inter-cell busbar 60 to adhere to each other.

The above-mentioned embodiment has shown an example in which each adhesive material 70 adheres the two adjacent electricity storage cells 10 to each other, but the present disclosure is not limited thereto. The adhesive material may cause three or more adjacent electricity storage cells 10 to adhere to each other.

The above-mentioned embodiment has shown an example in which the first adhesion part 71 and the second adhesion part 72 have the same shape and the same size, but the present disclosure is not limited thereto. The first adhesion part and the second adhesion part may have different shapes and different sizes. For examples, the width of the second adhesion part in the Y direction may be larger than the width of the first adhesion part in the Y direction. Further, the thickness of the second adhesion part in the X direction may be larger than the thickness of the first adhesion part in the X direction.

The above-mentioned embodiment has shown an example in which the cooler 40 is provided below the electricity storage cell 10, but the present disclosure is not limited thereto. The cooler may be provided above the electricity storage cell.

The above-mentioned embodiment has shown an example in which the electricity storage cells 10 are arrayed in the Y direction orthogonal to (intersecting with) the Z direction (height direction), but the present disclosure is not limited thereto. For example, the electricity storage cells 10 may be arrayed (stacked) in the Z direction.

The above-mentioned embodiment has shown an example in which the electricity storage device 100 is mounted on the vehicle 200, but the present disclosure is not limited thereto. The electricity storage device 100 may be provided on an electric device (for example, a stationary electricity storage device) other than the vehicle.

The above-mentioned embodiment has shown an example in which the first adhesion part 71 is provided at the center of the electricity storage cell 10 in the Z direction, but the present disclosure is not limited thereto. For example, the first adhesion part 71 may be provided in an upper portion of the electricity storage cell 10 (for example, in the vicinity of the upper surface 11).

The above-mentioned embodiment has shown an example in which the adhesive material 70 (71, 72) extends in the Y direction, but the present disclosure is not limited thereto. The adhesive material 70 (71, 72) may extend in the Z direction. Further, the adhesive material 70 (71, 72) may extend so as to intersect with each of the Z direction and the Y direction.

The above-mentioned embodiment has shown an example in which the adhesive material 70 (71, 72) has a band shape, but the present disclosure is not limited thereto. The adhesive material 70 (71, 72) may have a shape other than the band shape (for example, a square shape and a circular shape).

It should be understood that the embodiments disclosed herein are illustrative and non-restrictive in every respect. The scope of the present disclosure is defined by the terms of the claims, rather than the description above, and is intended to include any modifications within the scope and meaning equivalent to the terms of the claims.

What is claimed is:

1. An electricity storage device comprising:
an electricity storage module including a plurality of electricity storage cells arrayed in a first direction;
a case that accommodates the electricity storage module;
an adhesive material that causes the electricity storage cells to adhere to each other; and
an inter-cell busbar that connects, out of the electricity storage cells, electricity storage cells adjacent to each other in the first direction, wherein
each of the electricity storage cells includes:
a side surface in a second direction intersecting with the first direction; and
a terminal provided on the side surface,
the electricity storage cells are disposed such that the terminals of the electricity storage cells adjacent to each other in the first direction are adjacent to each other,
the inter-cell busbar connects the terminals adjacent to each other, and
the adhesive material causes the side surfaces adjacent to each other in the first direction to adhere to each other.

2. The electricity storage device according to claim 1, wherein the adhesive material causes the adjacent side surfaces respectively provided with the adjacent terminals that are connected by the inter-cell busbar to adhere to each other.

3. The electricity storage device according to claim 1, wherein the adhesive material includes a first adhesion part and a second adhesion part that are provided such that the inter-cell busbar is interposed between the first adhesion part and the second adhesion part.

4. The electricity storage device according to claim 1, further comprising a cooler including a cooling surface on which the electricity storage cells are arrayed, wherein the adhesive material is provided on the cooler side with respect to the inter-cell busbar.

5. The electricity storage device according to claim 1, wherein the adhesive material has a band shape extending in the first direction.
